(19) United States
(12) Patent Application Publication
(10) Pub. No.: US 2014/0136361 A1
(43) Pub. Date: May 15, 2014

(54) AVATAR HAVING ARTIFICIAL INTELLIGENCE FOR IDENTIFYING AND PROVIDING PURCHASING RECOMMENDATIONS

(71) Applicant: Robert Brazell, Salt Lake City, UT (US)

(72) Inventor: Robert Brazell, Salt Lake City, UT (US)

(21) Appl. No.: 13/926,960

(22) Filed: Jun. 25, 2013

Related U.S. Application Data
(60) Provisional application No. 61/726,439, filed on Nov. 14, 2012.

(51) Int. Cl. G06Q 30/06

(52) U.S. Cl. CPC G06Q 30/0631
USPC 705/26.7

(57) ABSTRACT

The present invention extends to methods, systems, and computer program products for implementing an avatar having artificial intelligence for identifying and providing purchasing recommendations. The avatar acts as an electronic representation of a user. The avatar can quantify the utility of decisions and recommend decisions or make decisions on behalf of the user based on the quantified utility determined for a set of decisions. In this way, the avatar can continually learn how to make the best decisions for the user to maximize the happiness of the user. The user can also enter into personal decision contracts which are commitments to follow a decision made by the avatar. A score representing how often the user follows the avatar's decisions can be maintained as an indication of the trustworthiness of the user in entering into personal decision contracts.

### CROSS-REFERENCE TO RELATED APPLICATIONS

This application claims the benefit of U.S. Provisional Patent Application No. 61/726,439 which was filed on Nov. 14, 2012.

### BACKGROUND

An average person may spend many hours a day making decisions. For example, a person makes many decisions regarding what to do with the person's time, what to spend money or resources on, who to interact with, etc. Such decisions are often made using only minimal information without considering the overall effect the decisions will have on the person's short or long-term well-being.

One reason why such decisions are made on limited information is that an adequate system of measuring the utility generated by making decisions does not exist. For example, although a price can be placed on many items, activities, or services that a person may desire, the price does not quantify the benefit or detriment the person will incur when making such a purchase.

### BRIEF SUMMARY

The present invention extends to methods, systems, and computer program products for implementing an avatar having artificial intelligence for quantifying the utility of items and making purchasing recommendations based on the quantified utility of the items. An avatar acts as a digital representation of a user by continually searching for information and analyzing the information to provide quantified measurements of the utility of decisions the user may make.

By generating quantified measurements of the utility of a decision, the avatar can provide the user with a simplified way to make educated decisions that will maximize the user's happiness. These decisions can relate to how the user spends his money or other resources, how the user spends his time, or any other type of decision that may have an effect on the user's well-being. For example, the decisions may relate to health care procedures or health related activities to improve the user's health, education or training to improve the user's economic worth, material possessions, etc.

The user can also enter into personal decision contracts using the avatar. These personal decision contracts can be commitments to follow a decision recommended by the avatar at a future time. Such contracts can be entered into with other entities or avatars. The avatar can maintain a score that represents the level of trust that the user has in the avatar which is based on how often the user complies with his commitments in a personal decision contract.

In one embodiment, the present invention is implemented as a method for providing a purchasing recommendation to a user. User input is received that identifies a plurality of characteristics of a user. Information available to one or more computing devices is analyzed. The information identifies one or more benefits of making a decision. Based on the plurality of characteristics of the user, a quantified measurement of the utility that the user would receive by making the decision is generated. It is determined that the quantified measurement exceeds a threshold. A recommendation is then displayed to the user that recommends that the user make the decision.

In another embodiment, the present invention is implemented as a method for entering into a personal decision contract using an avatar. An avatar identifies criteria by which a decision will be made in the future. The avatar then recommends to a user that the decision be followed. The avatar receives an agreement from the user that the user will make the decision at a future time based on the identified criteria. At the future time, the avatar applies the criteria to identify the decision to be made. The avatar then tracks whether the user follows the decision.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIGS. 1-2 illustrate an exemplary computer environment in which the present invention can be implemented;

FIG. 3 illustrates an exemplary display that can be provided to enable a user to interact with an avatar;

FIG. 4 illustrates a flowchart of an example method for providing a purchasing recommendation to a user; and

FIG. 5 illustrates a flowchart of an example method for entering into a personal decision contract using an avatar.

### DETAILED DESCRIPTION

The present invention extends to methods, systems, and computer program products for implementing an avatar having artificial intelligence for quantifying the utility of items and making purchasing recommendations based on the quantified utility of the items. An avatar acts as a digital representation of a user by continually searching for information and analyzing the information to provide quantified measurements of the utility of decisions the user may make.

By generating quantified measurements of the utility of a decision, the avatar can provide the user with a simplified way to make educated decisions that will maximize the user's happiness. These decisions can relate to how the user spends his money or other resources, how the user spends his time, or any other type of decision that may have an effect on the user's well-being. For example, the decisions may relate to health care procedures or health related activities to improve the user's health, education or training to improve the user's economic worth, material possessions, etc.

The user can also enter into personal decision contracts using the avatar. These personal decision contracts can be commitments to follow a decision recommended by the avatar at a future time. Such contracts can be entered into with other entities or avatars. The avatar can maintain a score that represents the level of trust that the user has in the avatar which is based on how often the user complies with his commitments in a personal decision contract.

In one embodiment, the present invention is implemented as a method for providing a purchasing recommendation to a user. User input is received that identifies a plurality of characteristics of a user. Information available to one or more computing devices is analyzed. The information identifies one or more benefits of making a decision. Based on the plurality of characteristics of the user, a quantified measurement of the utility that the user would receive by making the decision is generated. It is determined that the quantified measurement exceeds a threshold. A recommendation is then displayed to the user that recommends that the user make the decision.

In another embodiment, the present invention is implemented as a method for entering into a personal decision contract using an avatar. An avatar identifies criteria by which a decision will be made in the future. The avatar then recommends to a user that the decision be followed. The avatar receives an agreement from the user that the user will make the decision at a future time based on the identified criteria. At the future time, the avatar applies the criteria to identify the decision to be made. The avatar then tracks whether the user follows the decision.

### Example Computer Architecture

Embodiments of the present invention may comprise or utilize special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

### Example Computer Environment

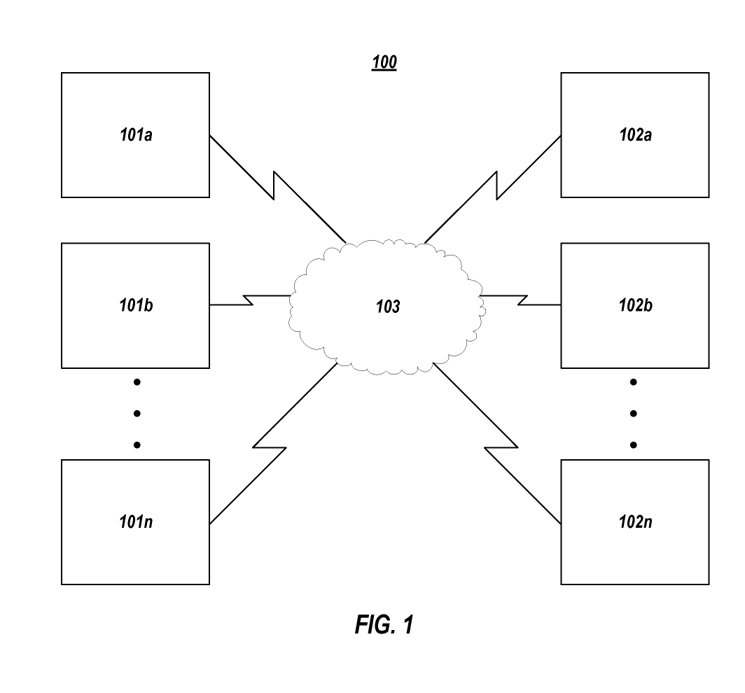

FIG. 1 illustrates an example computer environment 100 in which the present invention can be implemented. Computer environment 100 includes server computing systems 101a-101n and client computing devices 102a-102n which are connected via a network 103. Computer environment 100 in a typical environment can represent the internet.

Server computing systems 101a-101n represent any type of computer system connected to network 103 that stores content accessible from one or more of client computer devices 102a-102n. For example, each of server computing systems 101a-101n can comprise any number of computer systems or resources such as a single server or a cloud of interconnected computer resources. In other words, the present invention should not be limited to any particular computer or network configuration or infrastructure.

Client computing devices 102a-102n can represent any type of computing device capable of communicating with any of server computing systems 101a-101n over network 103. Examples of client computing devices 102a-102n include desktop computers, laptop computers, tablets, mobile phones, other smart electronic devices, etc. Although in most implementations, network 103 will be the internet, any type of network or direct connection between a client computer device 102 and a server computing system 101 could be used in addition to or in place of the internet.

### Identifying and Providing Purchasing Recommendations

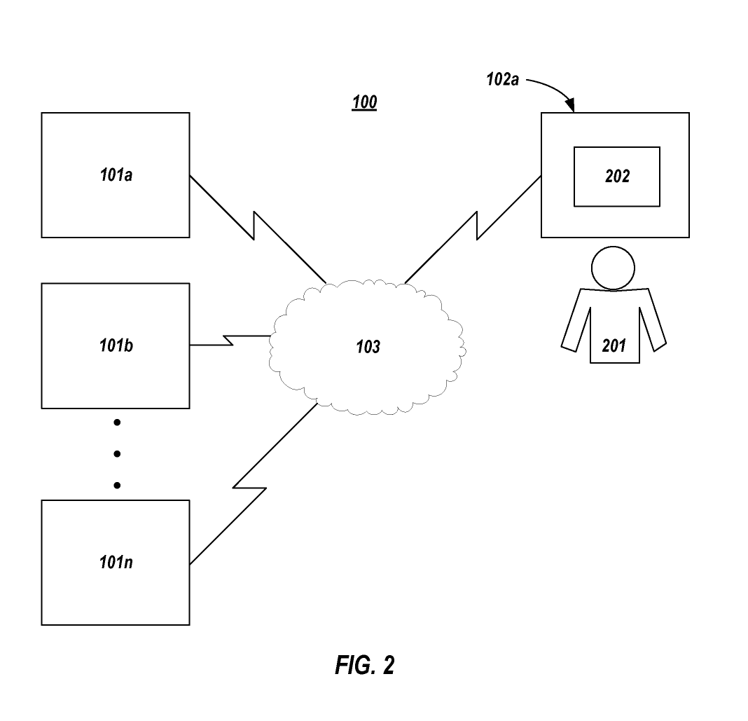

FIG. 2 represents computer environment 100 when a user 201 is using client computing device 102a to communicate with an avatar 202 in accordance with one or more embodiments of the invention. Avatar 202 comprises computer executable logic for obtaining information from user 201, searching for and identifying relevant information available via network 103, and using the information obtained from the user and via network 103 to present purchasing recommendations to user 201. In some embodiments, avatar 202 can be displayed on a computer device as a person, character, animal, or other figure which interacts with user 201.

Although avatar 202 is shown as being located on client computing device 102a, it is to be understood that not all of the logic for implementing avatar 202 needs to be located on client computing device 102a. For example, avatar 202 can be based on one or more of server computer systems 101a-101n (e.g. server-based or cloud-based) with a user interface being provided locally on client computing device 102a to interface with user 201. Similarly, logic for implementing avatar 202 can be stored locally on client computing device 102a while the information learned by avatar 202 can be hosted partially or entirely on one or more of server computing systems 101a-101n. Of course, logic for implementing avatar 202 can be provided on multiple of client computing devices 102a-102n such as when user 201 uses a home computer, a work computer, and a mobile phone/tablet to interface with avatar 202. Accordingly, the specific manner in which avatar 202 is hosted is not essential to the invention.

Avatar 202 continually receives information via network 103 and from user 201 to enable avatar 202 to recommend decisions to user 201 that user 201 would likely make if he were making the decision himself. The information received from user 201 can include initial information received from user 201, as well as user 201's responses to previously presented recommendations.

Avatar 202 can be configured to continually learn about user 201. For example, avatar 202 can obtain information about medical, educational, financial, and preference characteristics of user 201. Medical characteristics can include user 201's genetic information, health history, current well-being, etc. Educational characteristics can include user 201's knowledge, training, or experience in various subjects or fields. Financial characteristics can include user 201's financial status such as available cash, investments, debt, property, etc. Preference characteristics can include any other information about user 201 such as activities the user enjoys, habits, previous interaction that user 201 has had with avatar 202, etc. In short, avatar 202 can learn any type of information about user 201 thereby allowing avatar 202 to most effectively function as a digital representative of user 201.

In addition to learning information about user 201, avatar 202 can also be configured to learn information from virtually any digitally available source. For example, avatar 202 can search over the internet for medical, educational, financial, health, or recreational information. Avatar 202 can be configured to analyze this information to determine both the value of the information to user 201 as well as the value of the information in identifying decisions to recommend to user 201. In other words, some information in and of itself may be sufficiently valuable to present to user 201 whereas other information may be used, analyzed, compiled, or otherwise processed by avatar 202 to assist avatar 202 in identifying which decisions will yield maximum utility when taken by user 201.

Because it learns information about user 201, avatar 202 is able to determine the personal benefit a decision will have on user 201. For example, the information obtained and analyzed by avatar 202 can have different levels of benefit or detriment for a particular individual. However, because avatar 202 is configured to quantify the utility of a decision based on what it knows about user 201, avatar 202 can identify a decision that user 201 would likely make if user 201 were to analyze the same information. In this way, avatar 202 can free user 201 from having to take the time to become sufficiently informed to make a decision that will maximize utility.

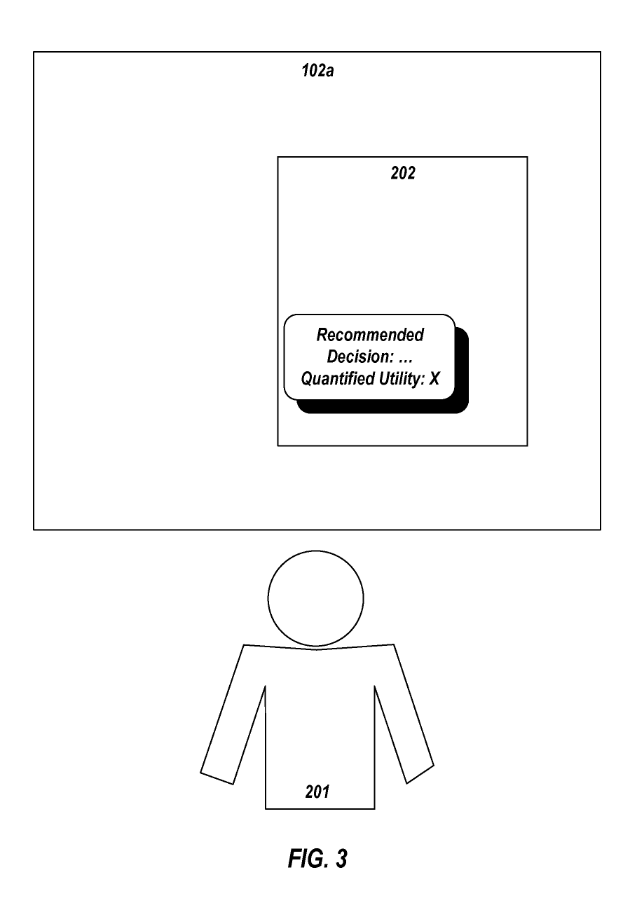

To assist user 201 in determining whether to accept a particular decision, avatar 202 can be configured to generate a quantified measurement of the utility of making the decision as shown in FIG. 3. The quantified measurement can take various forms based on the type of decision with which it is associated. For example, if the decision is a medical based decision, the quantified measurement can be based on the number of years that the decision will likely add to user 201's life expectancy. In such cases, the quantified measurement can also be based on the cost of making the decision such as the financial cost of undergoing a medical procedure or the cost of devoting time to make the decision.

In some embodiments, avatar 202 can also be configured to identify how user 201 is spending time or money on other decisions and can make recommendations to reallocate the time or money to make another decision that will provide more utility. For example, if avatar 202 determines that user 201 would greatly benefit by undergoing an expensive medical procedure, avatar 202 may determine the best way to reallocate user 201's funds to be able to pay for the medical procedure. In such cases, the quantified measurement can include a comparison of the benefit and cost.

In some cases, the decision may relate only to financial aspects of user 201's life. In such cases, the quantified measurement can include an indication of the cost of making a decision versus the expected increase in user 201's economic value from making the decision. For example, avatar 202 can determine based on discovered information that user 201 would likely increase his economic value by taking a class, reading a book, receiving training, etc. Avatar 202 can generate a quantified value that is based on the difference between the added economic value and the cost (in terms or money and/or time). In other words, added economic value can represent an increase in user 201's knowledge, experience, relevant information, or insight.

In some embodiments, avatar 202 can represent user 201 in a marketplace. Avatar 202 can include a score or other indicator representing user 201's various characteristics. For example, avatar 202 can portray user 201's financial, educational, medical, or recreational characteristics. These scores or indicators can be presented to other users or to other users' avatars thereby allowing others to enter into trades with user 201 via avatar 202.

In one example, these scores can be used to identify the trustworthiness of user 201 in keeping commitments entered into via the marketplace. For example, if avatar 202 presented a decision to user 201 recommending that user 201 enter into a commitment to purchase a certain product for a specified duration of time, avatar 202 can maintain a score that reflects whether user 201 upheld the commitment to purchase the product. One or more scores can similarly reflect user 201's history regarding commitments to exchange knowledge with other users, to receive certain services, or to enter into any other type of agreement. In this way, the marketplace, and more specifically avatar 202, enables user 201 to directly enter into agreements with other users or entities.

This marketplace can act as an exchange for entering into personal decision contracts. In other words, user 201 can agree to follow avatar 202's recommended decisions based on the assumption that avatar 202 identifies and recommends decisions that will most likely yield the greatest utility to user 201. As stated above, these decisions can be of any type including financial decisions (e.g. what car to buy, how to spend one's time), medical decisions (e.g. what preventative procedures to receive), educational decisions (e.g. what or where to learn), etc.

Once user 201 has agreed to follow avatar 202's decisions, user 201 can be freed from making these decisions himself. User 201's trustworthiness in keeping these commitments can act as an indication to other users (or other users' avatars) regarding the risk of entering into personal decision contracts with user 201.

For example, if avatar 202 recommends that user 201 purchase a particular car every four years for the next sixteen years, and another user (e.g. an auto dealer) agrees to sell the particular car at a specified price, each parties' commitment to this personal decision contract (and to other personal decision contracts) can be tracked and represented as a score of the user's commitment to contracts.

This score would be similar to a person's credit score. However, in contrast to a credit score, this score represents user 201's commitment to follow avatar 202's recommended decisions. The following example emphasizes this distinction. User 201 could agree to follow avatar 202's decision to purchase the best car for user 201 every four years. At the time that user 201 enters into this personal contract, user 201 does not know what car will be best, but still commits to allow avatar 202 to make the determination of which car is best for user 201 every four years. This personal decision contract could be entered into with a single car manufacturer (e.g. avatar 202 selects the best Ford model car), or can be entered into with multiple car manufacturers thereby incentivizing the multiple manufacturers to produce cars that will be best for user 201 (and therefore will be selected by avatar 202).

This example illustrates how avatar 202 can free user 201 from spending the required time to make the decision to purchase a car. Without avatar 202, user 201 has to do his own research every four years to determine which car to purchase. Further, user 201 will likely not perform sufficient research to be fully informed regarding which cars will be best for him. Avatar 202 performs this research for user 201 and uses the information that it knows about user 201 to make the best decision. As long as user 201 trusts avatar 202's decisions, user 201 is freed from the time and effort of making these and other types of personal decisions.

Companies or other entities can benefit by supplying necessary information for avatar 202 to make appropriate decisions. These companies can also benefit by receiving feedback from avatar 202 (and avatars of other users) that will assist the companies in producing goods or services that will provide the most benefit to the end users. In short, this marketplace can replace traditional means of advertising and selling goods or services by providing direct access to customers and their specific needs and desires as determined by their avatars. Further, by using avatars as representations of users, the users' identities can remain anonymous during this process.

As another example, this marketplace can be used to create a personal decision contract to have a cancer screening procedure performed every year. Avatar 202, based on the information it has learned about user 201 (e.g. genetics, health history, family history, etc.) can determine that user 201 has a high risk of developing a certain cancer. Avatar 202 can also identify that a certain procedure is the best current procedure for early detection of the cancer and can enter into a personal decision contract on behalf of user 201 to have user 201 receive the procedure.

Further, avatar 202 can also determine that it is best for user 201 to have the best procedure available performed every year. Avatar 202 can research available information to determine criteria that can be used to select the best procedure in the future. Avatar 202 can then enter into a contract with an entity (e.g. a doctor, a clinic, a hospital, etc.) to provide the current best procedure each year for a specified duration of time. In this way, user 201 enters into a contract to have a procedure performed each year without knowing beforehand which procedure will be performed. User 201 relies on avatar 202 to make the best decision (which in this example is the decision of which criteria will be used to select a procedure in the future) given the available information.

Each year, user 201 fulfills his commitment to the personal decision contract by undergoing the cancer prevention procedure that is determined to be the best for user 201 at that time. User 201 is freed from having to continually research available options while still retaining the assurance that he is doing all he can to minimize his risk of developing cancer.

In the above example, if the personal decision contract is made with a particular clinic that performs cancer screening procedures, the clinic can use a score or other indicator provided by avatar 202 to determine whether to enter into the contract with user 201. For example, the contract can specify that user 201 will receive the procedure at a discounted rate each year in exchange for the commitment to have the best available procedure performed at the clinic each year. If the score maintained by avatar 202 indicates that user 201 generally keeps his commitment to follow avatar 202's decisions, the clinic will be better informed regarding user 201's likelihood of honoring the contract by having the procedure performed each year.

It is again noted that the score does not represent user 201's history of making payments as with a credit score, but is instead an indication of user 201's history of following avatar 202's recommendations when user 201 has agreed to do so. In the above example, the score represents user 201's likelihood of having a procedure, that is selected by avatar 202 (i.e. by the criteria specified by avatar 202), even when user 201 does not know the specific procedure that will be performed at the time of entering into the personal decision contract. In other words, the score can also be viewed as a representation of how much trust user 201 has in avatar 202.

In summary, avatar 202 constantly learns about user 201 and about any available information that is relevant to user 201's wellbeing. Avatar 202 uses this information to recommend decisions that are most likely to yield the greatest degree of utility or happiness to user 201. User 201's trust in avatar 202 can be quantified and used as a score in a marketplace where other entities or users can enter into personal decision contracts with user 201. These personal decision contracts are commitments to follow decisions made by avatar 202.

### Example Method for Identifying and Providing Purchasing Recommendations

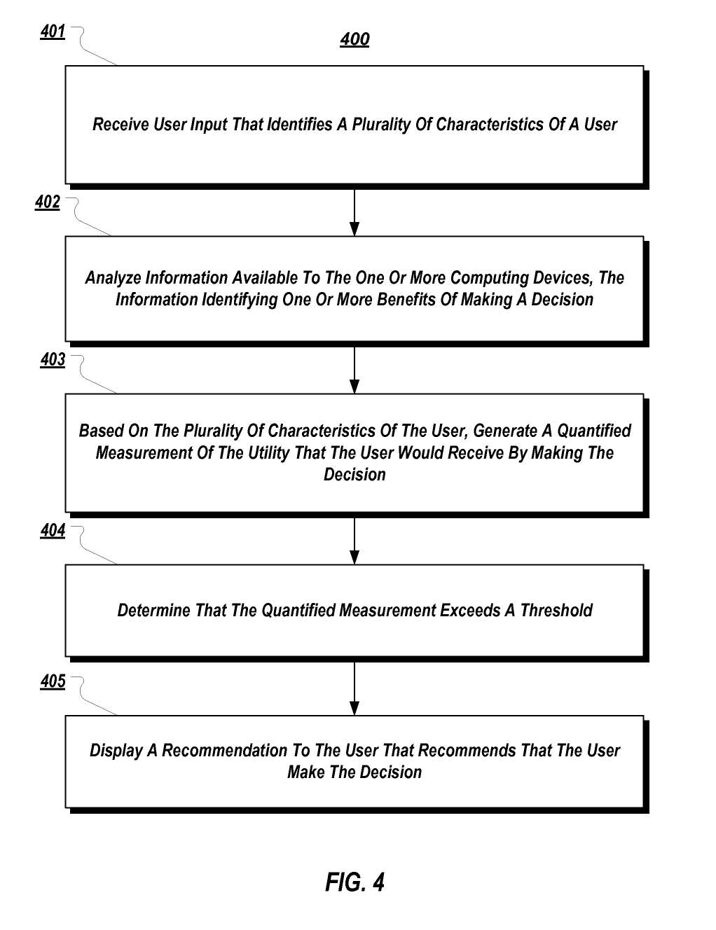

FIG. 4 illustrates a flowchart of an example method 400 for providing a purchasing recommendation to a user. Method 400 will be described with reference to FIGS. 1 and 2.

Method 400 includes an act 401 of receiving user input that identifies a plurality of characteristics of a user. For example, user 201 can provide input that identifies medical, educational, financial, or preference characteristics of the user.

Method 400 includes an act 402 of analyzing information available to the one or more computing devices, the information identifying one or more benefits of making a decision. For example, avatar 202 can search information available over the internet or another network to identify benefits of making a decision.

Method 400 includes an act 403 of, based on the plurality of characteristics of the user, generating a quantified measurement of the utility that the user would receive by making the decision. For example, avatar 202 can identify a quantified measurement of making a decision based on the characteristics avatar 202 knows about user 201.

Method 400 includes an act 404 of determining that the quantified measurement exceeds a threshold. For example, avatar 202 can determine that the quantified measurement exceeds a specified threshold indicating that the decision should be recommended to user 201.

Method 400 includes an act 405 of displaying a recommendation to the user that recommends that the user make the decision. For example, avatar 202 can display a recommendation to user 201 that recommends that user 201 makes the decision.

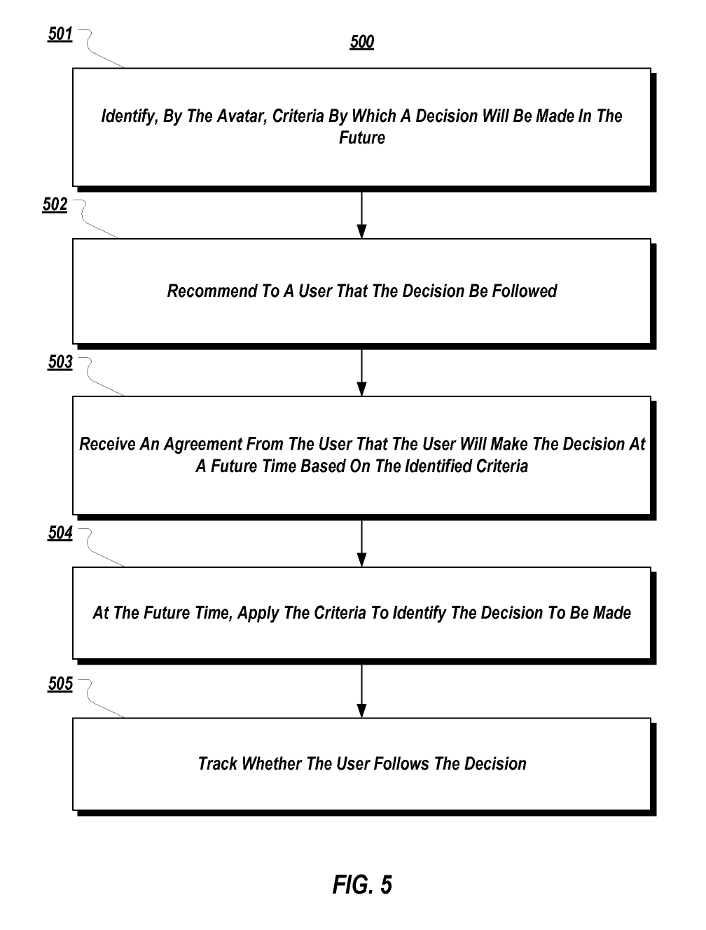

FIG. 5 illustrates a flowchart of an example method 500 for entering into a personal decision contract using an avatar. Method 500 will be described with reference to FIGS. 1 and 2.

Method 500 includes an act 501 of identifying, by the avatar, criteria by which a decision will be made in the future. For example, avatar 202 can identify criteria that can be used at a future time to make an appropriate decision for user 201.

Method 500 includes an act 502 of recommending to a user that the decision be followed. For example, avatar 202 can display a recommendation to user 201 that user 201 follow make a decision in the future based on the identified criteria.

Method 500 includes an act 503 of receiving an agreement from the user that the user will make the decision at a future time based on the identified criteria. For example, avatar 202 can receive user input from user 201 that identifies that user 201 agrees to make the decision in the future based on the identified criteria.

Method 500 includes an act 504 of, at the future time, applying the criteria to identify the decision to be made. For example, avatar 202 can apply the criteria at a future time to make the decision for user 201.

Method 500 includes an act 505 of tracking whether the user follows the decision. For example, avatar 202 can track whether user 201 follows the decision made by avatar 202.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A method, performed by one or more computing devices, for providing a purchasing recommendation to a user, the method comprising;
receiving user input that identifies a plurality of characteristics of a user;
analyzing information available to the one or more computing devices, the information identifying one or more benefits of making a decision;
based on the plurality of characteristics of the user, generating a quantified measurement of the utility that the user would receive by making the decision;
determining that the quantified measurement exceeds a threshold; and
displaying a recommendation to the user that recommends that the user make the decision.

2. The method of claim 1, wherein the plurality of characteristics include one or more of:
medical characteristics of the user;
educational characteristics of the user;
financial characteristics of the user; or
preference characteristics of the user.

3. The method of claim 1, wherein the plurality of characteristics include indications of whether the user followed previous recommendations.

4. The method of claim 1, wherein the information available to the one or more computing devices comprises information available over the internet, and wherein analyzing the information comprises continually searching the internet for information that identifies the benefit of making the decision.

5. The method of claim 1, wherein the quantified measurement comprises one or more of:
a representation of the number of years of life that the user is expected to gain by making the decision; or
a representation of an increase in economic value that the user is expected to gain by making the decision.

6. The method of claim 1, further comprising:
displaying a representation of the cost of making the decision.

7. The method of claim 6, wherein the cost is represented as one or more of:
an amount of money; or
an amount of time.

8. The method of claim 7, wherein the amount of time is a number of years that the user is expected to lose from the user's life expectancy by making the decision.

9. The method of claim 1, wherein determining that the quantified measurement exceeds a threshold comprises determining that the quantified measurement exceeds a quantified measurement generated for another decision that the user has already taken.

10. The method of claim 1, wherein determining that the quantified measurement exceeds a threshold comprises determining that a number of years that the user is expected to gain by making the decision exceeds a financial cost of making the decision by a specified amount.

11. The method of claim 1, wherein the decision comprises teaching information to another user, and wherein the quantified measurement of the utility of teaching the information to another user is generated by comparing the amount of money the other user is willing to pay to be taught to the amount of money the user can obtain by spending the time required to teach the information making another decision.

12. The method of claim 1, wherein the decision comprises purchasing a product.

13. The method of claim 12, wherein the decision further comprises agreeing to purchase the product for a specified duration of time.

14. The method of claim 1, wherein the decision comprises undergoing a medical procedure, and wherein the quantified measurement comprises an indication of the number of years the medical procedure is likely to add to the user's lifespan.

15. The method of claim 14, wherein the quantified measurement further comprises a comparison of the number of years to a cost of the medical procedure.

16. The method of claim 15, further comprising:
displaying a recommendation of alternate ways that the user can spend financial resources to enable the user to pay the cost of the medical procedure.

17. The method of claim 1, further comprising:
receiving input from the user that accepts the recommendation; and
tracking the user's compliance with the recommendation.

18. The method of claim 17, further comprising:
generating a score that represents the user's compliance with a plurality of recommendations that the user has accepted.

19. The method of claim 18, further comprising:
displaying the score to other users.

20. The method of claim 18, wherein the decision comprises an agreement to purchase a product during a duration of time, the score representing whether the user purchases the product during the duration of time.

21. The method of claim 1, wherein the decision comprises agreeing to pay another user for an item, and wherein the quantified measurement is based on a reliability score of the other user.

22. The method of claim 21, wherein the item is knowledge, experience, information, or insight of the other user.

23. A method for entering into a personal decision contract using an avatar, the method comprising:
identifying, by the avatar, criteria by which a decision will be made in the future;
recommending to a user that the decision be followed;
receiving an agreement from the user that the user will make the decision at a future time based on the identified criteria;
at the future time, applying the criteria to identify the decision to be made; and
tracking whether the user follows the decision.
